(19) United States
(12) Patent Application Publication
(10) Pub. No.: US 2003/0230419 A1
(43) Pub. Date: Dec. 18, 2003

(54) Garden tool for grubbing

(76) Inventor: Loy Eubanks, Melbourne, FL (US)

Correspondence Address: PATTON BOGGS, PO BOX 270930, LOUISVILLE, CO, 80027, US

(21) Appl. No.: 10/460,073

(22) Filed: Jun. 12, 2003

Related U.S. Application Data
(60) Provisional application No. 60/374,255, filed on Jun. 13, 2002.

(51) Int. Cl. A01B 1/00

(52) U.S. Cl. 172/371

(57) ABSTRACT

The present garden tool for grubbing includes an elongated handle attached with and approximately perpendicular to, a grub hoe blade. The grub hoe blade has a proximal end and a distal end wherein the distal end is narrower than the proximal end. The grub hoe blade may include a rounded tip or the distal end may be straight. The end and the sides of the grub hoe blade are sharp to allow the grub hoe blade to easily penetrate compact or rooty soil. The grub hoe blade is arcuate and the neck is connected with the handle approximately central to the grub hoe blade along a longitudinal axis, thereby balancing the present garden tool for grubbing during use.

### CROSS-REFERENCE TO RELATED APPLICATIONS

This application claims the benefit from U.S. Provisional Patent Application Serial No. 60/374,255 filed Jun. 13, 2002 and titled “Weed N' dig—A.K.A.—hoe-shovel”.

### FIELD OF THE INVENTION

This invention relates generally to a garden tool and more particularly, to a garden tool having a grub hoe blade.

### PROBLEM

It is a problem in the field of grubbing, the clearing or digging up roots and stumps, to have all of the tools required to complete the task at hand. It is also a problem when grubbing in areas where the user travels a distance on foot with the required tools, using the tools along the way or at the destination. For example, grubbing tools are used for constructing and maintaining trails and are also used by forest service firefighters. Particularly in remote or steep terrain it is difficult to have to carry several long-handled tools, such as different types of axes, shovels, rakes and hoes, to the work site. Furthermore, it is difficult to keep the variety of tools readily available when moving through different types of vegetation and ground cover. The user must have the variety of tools when he is transported to the work site and is likely to encounter any type of terrain in the geographical region. Therefore, a number of combination tools have been developed to perform two or more functions.

One type of known grubbing tool is the combination tool, which consists of two or more different types of tool implements connected with a single handle. Referring to FIG. 1a, well know combination tool 10 used by forest service firefighters is a combination mattock and hoe, commonly referred to as a “Pulaski” after the designer of the tool. The Pulaski grubbing tool combines an axe 14 and a grub hoe 12 into one multipurpose firefighting tool that is easily adapted for trail work, especially for crews limited to a few tools, or crews with only a general idea of the job to be done.

Other combination tools with grub hoe blades are available for clearing or digging up roots and stumps, including a variety of mattocks and hoes. The cutter mattock 20 illustrated in FIG. 1b includes a grub hoe blade 22 opposite a cutter blade 24, while the pick mattock 30 has a grub hoe blade 32 opposite a pointed tip, or pick 34. Crews working in deep, rooty soil often prefer the cutter mattock. The roots are severed with the cutter blade and then pried out with the grubbing end. However, the pointed end of the pick mattock is useful for breaking rocks while the grub hoe blade is used for working softer materials. The grub hoe blade of the cutter mattock and the pick mattock may also be used to cut roots or to remove small stumps.

The Pulaski 10, cutter mattock 20 and the pick mattock 30 all use a similar grub hoe blade as illustrated in FIGS. 1a-1c. The grub hoe blade is wider at the distal end, requiring the user to swing the tool so that the edge of the grub hoe blade strikes the ground. Furthermore, the combination tools are made of forged steel which is heavier than a typical garden tool and therefore more fatiguing to use. Additionally, the grub hoe blade has a weight that is greater than the weight of the opposite tool making the grub hoe blade dominant over the opposite tool. When the grub hoe blade becomes dull through use, replacement of the entire tool head, including both the grub hoe blade and the opposite tool, is undesirably expensive. Attempts to improve the grub hoe blade by increasing the width at the distal end have made the tool more dangerous because of the increased unbalancing effect of the larger blade.

Combination tools are also less effective than single purpose tools. For example, an axe balances better and chops more safely than the Pulaski and the cutter mattock and grub hoes are more effective than the Pulaski, cutter mattock, and the pick mattock. Since the grub hoe blade is wider at the distal end, a second tool, a cutter, axe or pick, is necessary to soften the soil so that the grub hoe blade is effective.

A grubbing tool commonly used by gardeners is the draw, or swan neck hoe 40 illustrated in FIG. 2. The swan neck hoe 40 is used by gardeners for leveling or weeding the soil. The swan neck hoe 40 is a lightweight tool constructed of tempered steel with a wide, grub hoe blade for penetrating soft ground. However, when the ground is not soft, or is rooty, the light weight of the swan hoe combined with the width of the grub hoe blade prevents the blade from penetrating the ground. Therefore, the swan neck hoe is ineffective for compact soil or unusually bushy areas. A shovel having a pointed blade, an axe or a pick is often used to soften the soil. Once softened, the swan neck hoe is used to pry the roots out of the soil or to dig trenches for planting seeds.

Adze hoes 50, grub hoes 60, or hazel hoes 70 illustrated in FIGS. 3a-3c respectively, have shorter handles and are used to break sod clumps when constructing new trails or when leveling an existing trail head. These hoes can be used to break through heavy duff on the forest floor. Like the swan neck hoe, the grub hoe blade of the adze, grub and hazel hoes is wide, making it difficult to penetrate through duff, compact or rooty soil. The adze hoes 50, grub hoes 60, or hazel hoes 70 are also heavier, constructed of forged steel on a shorter handle, than the swan neck hoe or other typical garden tool, making them difficult and fatiguing to use.

The width of the grub hoe blade of the prior art combination tools, swan neck hoe, and the adze hoes, grub hoes, and hazel hoes is wider at the distal end of the grub hoe blade, resulting in a wide sharpened blade. The width of the grub hoe blade is not effective for digging into a hard soil, requiring the user to use the axe or a pick to soften the soil prior to using the grub hoe blade. Otherwise, it is recommend that the tool strike the ground so that the grub hoe blade hits at an angle on its corner.

The combination, or combi tool 80 illustrated in FIG. 4, is basically a military entrenching tool on a long handle. The combi tool functions as a hoe, pick, or shovel. The combi tool has a longer handle than the Pulaski, mattocks, and the adze, grub and hazel hoes, making the combi tool less fatiguing to use. The combi tool 80 includes a shovel type blade 82 that is hinged (at 86) to fold approximately perpendicular with the handle for use as a grubbing tool as illustrated in FIG. 4. When unfolded (not illustrated), the shovel blade functions as a shovel. Opposite of the folded shovel blade is a pick 84 for softening the ground prior to using the shovel blade 82.

Unlike the Pulaski, mattocks, and the adze, grub and hazel hoes which have a wide grub hoe blade, the width of the shovel blade on the combi tool decreases to a rounded end as illustrated in FIG. 4. The rounded end of the shovel blade allows the shovel blade to more effectively penetrate rooty or hard soil, however, the increasing width and decreasing sharpness of the shovel blade prevents the shovel blade from cutting deeply into the rooty or hard soil. Like the balancing problem encountered when using the Pulaski, cutter mattock and the pick mattock, the shovel blade has a weight that is greater than the weight of the pick, making the shovel blade dominant over the pick resulting is difficulty balancing the combi tool during use. While the combi tool is lighter in weight than the Pulaski, cutter mattock and the pick mattock, the hinge between the opposing tools weakens when used for grubbing, resulting in unwanted flexing of the shovel blade or failure of the combi tool.

For these reasons, a need exists for a grubbing tool that breaks the surface of the soil and digs deep enough to reach the roots of the vegetation for cleaning the area while also providing a sufficiently sharp straight surface to cut roots.

### SOLUTION

The present garden tool for grubbing includes an elongated handle attached with and approximately perpendicular to a grub hoe blade. The grub hoe blade has a proximal end and a distal end wherein the distal end is narrower than the proximal end. The grub hoe blade may include a rounded tip at the proximal end. The rounded tip and the sides of the grub hoe blade are sharp to allow the grub hoe blade to easily penetrate compact or rooty soil. Alternatively, the distal end of the grub hoe blade may be straight while maintaining a distal end that is substantially narrower than the proximal end. Like the grub hoe blade having a rounded tip, the straight edge and the sides are sharpened. The grub hoe blade is arcuate and the neck is connected with the handle approximately central to the grub hoe blade along a longitudinal axis, thereby balancing the present garden tool for grubbing during use.

### BRIEF DESCRIPTION OF THE DRAWINGS

FIG. 1a illustrates a prior art combination tool including mattock and hoe, commonly referred to as a Pulaski;

FIG. 1b illustrates another prior art combination tool having a grub hoe blade opposite a cutter blade;

FIG. 1c illustrates yet another prior art combination tool having a grub hoe blade opposite a pick;

FIG. 2 illustrates a swan neck hoe of the prior art;

FIG. 3a illustrates an adze hoe of the prior art;

FIG. 3b illustrates a grub hoe of the prior art;

FIG. 3c illustrates a hazel hoe of the prior art;

FIG. 4 illustrates yet another prior art combination tool having a folding shovel blade used for grubbing opposite a pick

FIG. 5 illustrates a perspective view of the present garden tool for grubbing;

FIG. 6 illustrates an example of a grub hoe blade of the present garden tool;

FIG. 7 illustrates another example of a grub hoe blade of the present garden tool;

FIG. 8 illustrates a rear view of the present garden tool;

FIG. 9 illustrates a side view of the present garden tool; and

FIG. 10 illustrates a top view of the present garden tool.

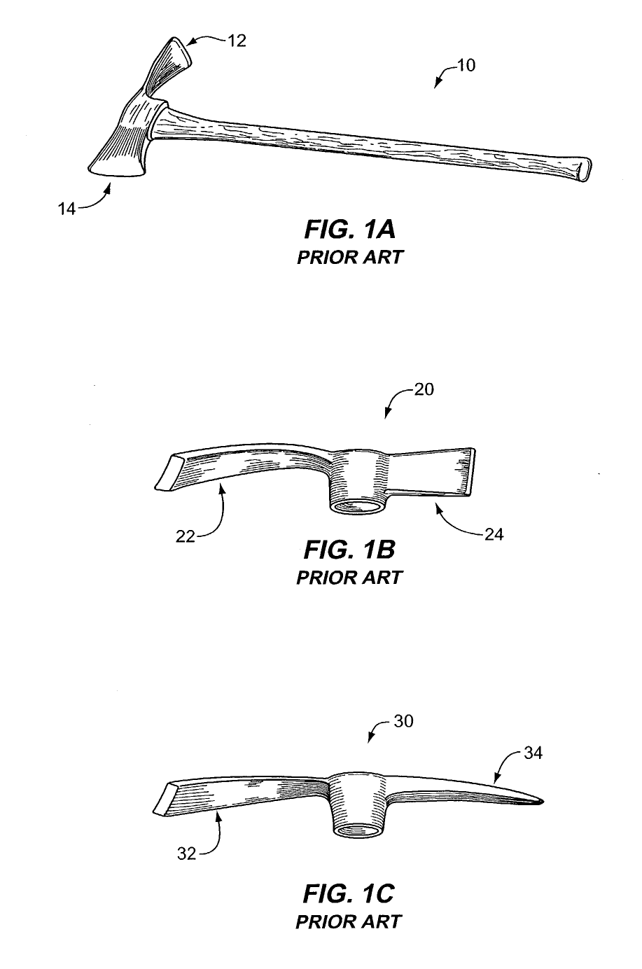

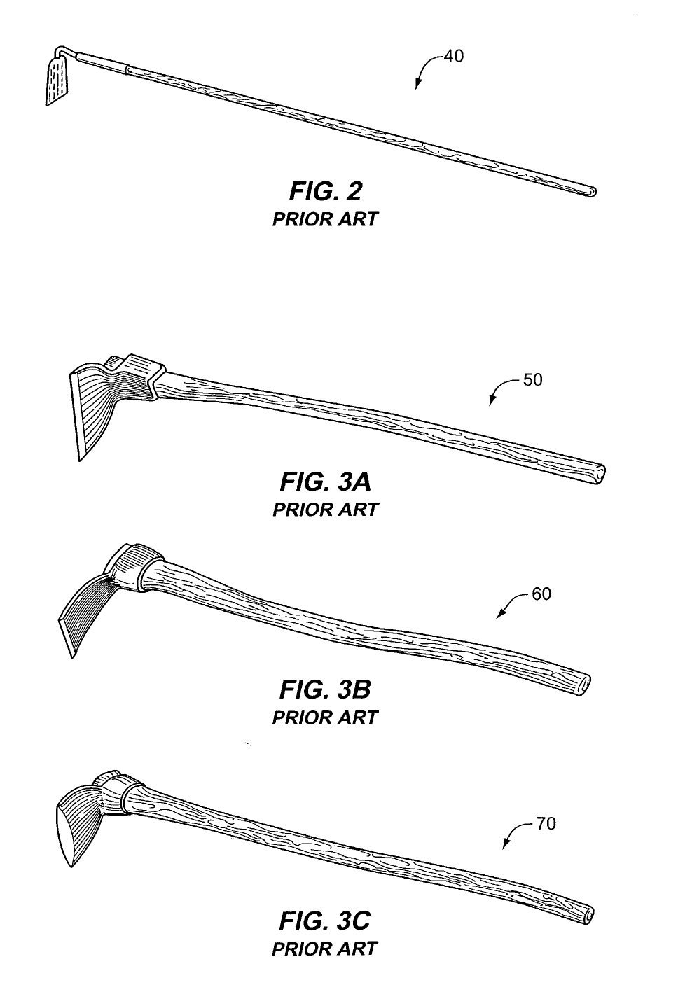

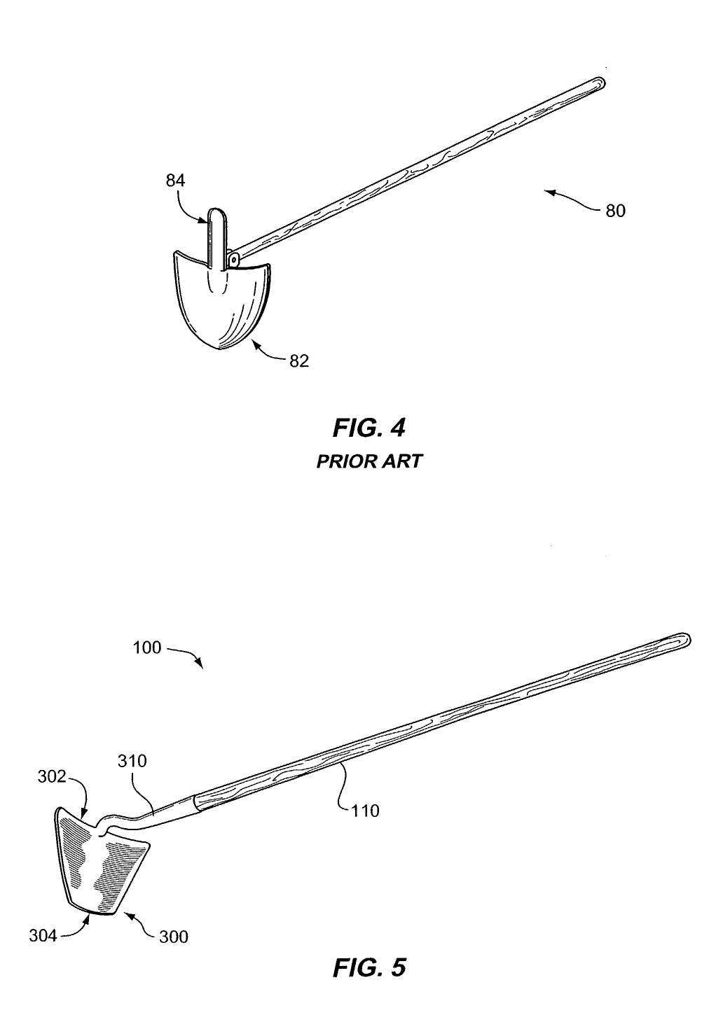

### DETAILED DESCRIPTION OF THE DRAWINGS

FIG. 5 illustrates a perspective view of the present garden tool for grubbing. The garden tool 100 includes an elongated handle 110 similar to those used with other garden tools and has a grub hoe blade 300 connected approximately perpendicular to elongated handle 110. The edges of the grub hoe blade 300 are sharpened to allow the grub hoe blade 300 to penetrate the ground and to cut through plant roots. Unlike prior art grub hoe blades wherein the width of the blade increases at the distal end, the grub hoe blade 300 of the present garden tool decreases at the distal end 304, allowing the grub hoe blade 300 to easily cut through compact or rooty soil. The present garden tool can be used for weeding an area, cutting through roots and for digging. Once the grub hoe blade is in the ground, the sharp edges of the grub hoe blade allows the user to drag the garden tool while the grub hoe blade cuts roots.

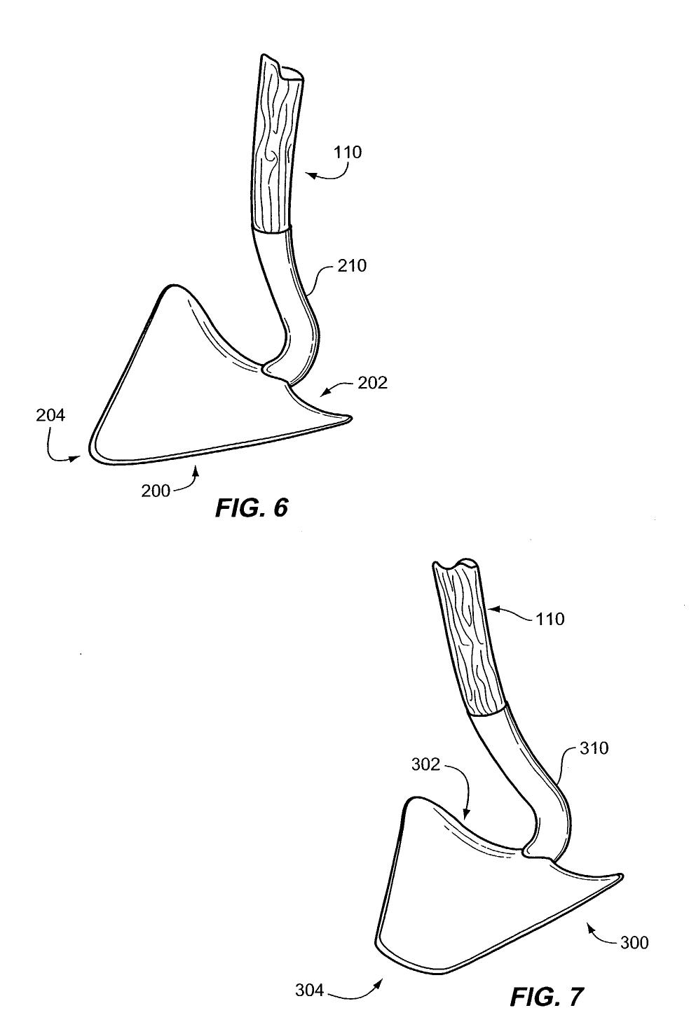

Referring to the garden tool 100 illustrated in FIG. 6, the grub hoe blade includes a substantially hollow neck 210 for receiving an end of a handle 110 for attaching the grub hoe blade 200 with the handle 110. The grub hoe blade 200 includes a proximal end 202 to which the handle is attached and a distal end 204. The distal end 204 may be a rounded nose as illustrated in FIG. 6 or straight as illustrated in FIG. 7. The rounded nose at the distal end 204 is sharpened for use cutting roots and to facilitate entry of the grub hoe blade 200 into compact or rooty soil. Unlike a traditional shovel or the shovel blade used for grubbing with the combi-tool, the sides of the grub hoe blade 200 of the present garden tool are substantially straight, not rounded. The shape of the grub hoe blade is substantially triangular rather than semicircular, as with the shovel. To facilitate the grub hoe blade 200 entering the ground to a greater depth, the sides of the grub hoe blade are sharpened the full length from the proximal end to the distal end. Crews working in deep, rooty soil can use the grub hoe blade 200 of the present garden tool 100 to cut the roots of the vegetation in the ground and to pry the roots out of the soil, reducing the number of tools required to complete the task.

Alternatively, the distal end 304 of the grub hoe blade 300 may be straight as illustrated in FIG. 7. The width of the distal end may vary while maintaining a width at the distal end 304 which is substantially less than the width of the grub hoe blade at the proximal end 302. When working in areas with rooty soil and shrubs, the straight blade is effective for cutting the roots and the branches of the shrub above the ground as well as roots within the soil. Prior art grubbing tools required the user to either use an axe or a cutter for cutting the roots and branches of the bushes, thereby dulling the axe or cutter as the axe or cutter strikes the ground.

The side of the grub hoe blade may be used to clear above the ground without digging up the dirt by simply dragging the sharp side blade across the ground. Both the straight end of the grub hoe blade and the side of the grub hoe blade of either embodiment may be used to clear vegetation above the ground without digging up the soil. The sharpness of the side blade cuts the vegetation above the ground. The grub hoe blade may also be used for digging gardening trenches. Once the grub hoe blade has penetrated the soil, the user merely drags the garden tool while the grub hoe blade cuts the roots of the vegetation as the trench is dug.

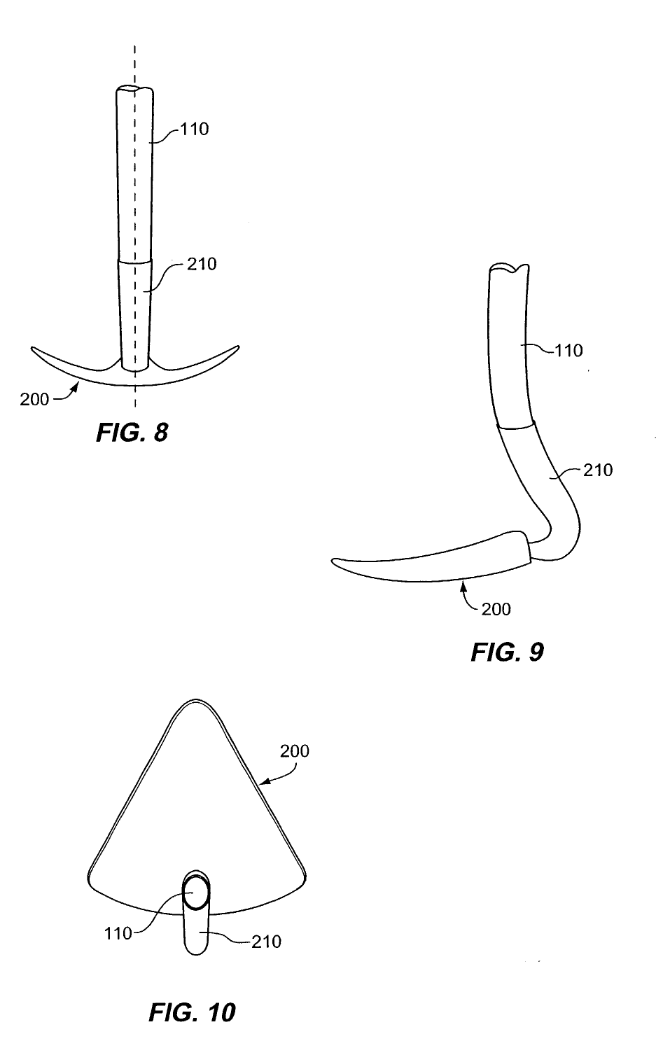

The neck 210 may resemble the neck of the swan neck hoe as illustrated in the side view of FIG. 9 to add durability and stability to the garden tool for grubbing. The swan neck decreases or eliminations the vibration of the grub hoe blade and handle caused when a swan neck to used to connect the grub hoe blade to the handle. The neck 210 is attached with the grub hoe blade 200 substantially central to the grub hoe blade 200 creating a longitudinal axis as illustrated in the rear view of FIG. 8. The centrally located longitudinal axis is useful for balancing the grub hoe blade during use. The present garden tool is lifted to a height necessary for penetrating the soil. The lighter weight of the grub hoe blade allows the user to balance the garden tool as the garden tool swings downwardly for the grub hoe blade to hit the ground. The shape of the grub hoe blade, narrow at the distal end, allows the grub hoe blade to penetrate the compact soil. When the grub hoe blades become dull through use, the blades are sharpened in a manner similar to sharpening other traditional garden tools. A pin, bolt or other fastener (not shown) may be used to ensure that the grub hoe blade remains attached to the handle during use. The fastener is inserted through the neck 210 and the end of the handle contained therein, to prevent the handle 110 from sliding out of the neck 210.

Referring to the rear view and the top view of the present garden tool in FIGS. 8 and 10 respectively, in an embodiment the grub hoe blade is arcuate, with the neck 210 and handle 110 centrally connected with the grub hoe blade to allow the user to balance the garden tool during use.

As to alternative embodiments, those skilled in the art will appreciate that the present garden tool for grubbing can be configured with alternative configuration of the grub hoe blade while maintaining a distal end which is narrower than the proximal end to allow the grub hoe blade to easily penetrate compact soil and to cut roots.

It is apparent that there has been described a garden tool for grubbing that fully satisfies the objects, aims, and advantages set forth above. While the garden tool for grubbing has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

What is claimed:

1. A garden tool comprising:
an elongated handle;
a grub hoe blade having a distal end and a proximal end, wherein the width of the grub hoe blade decreases from the proximal end to the distal end, the grub hoe blade comprising:
a first blade located at the distal end of the grub hoe blade, said first blade substantially sharp for cutting;
a second blade on a first side of the grub hoe blade, said second blade substantially sharp for cutting; and
a third blade on a second side of the grub hoe blade, said third blade substantially sharp for cutting; and
a means for receiving an end of the elongated handle, the receiving means connected to and approximately perpendicular with the proximal end of the grub hoe blade and defining the longitudinal axis of the garden tool.

2. The garden tool of claim 1 wherein the grub hoe blade is approximately triangular.

3. The garden tool of claim 1 wherein the first blade is a rounded nose.

4. The garden tool of claim 1 wherein the first blade is substantially straight.

5. The garden tool of claim 1 wherein the receiving means further comprises a fastener passing through the receiving means and the end of the elongated handle within the receiving means.

6. The garden tool of claim 1 wherein the second blade and the third blade extend approximately from the distal end to the proximal end.

7. The garden tool of claim 1 wherein the grub hoe blade is curved along the longitudinal axis.

8. A garden tool for grubbing comprising:
an elongated handle;
an arcuate grub hoe blade having a distal end and a proximal end, wherein the width of the grub hoe blade decreases from the proximal end to the distal end, the grub hoe blade comprising:
a first blade located at the distal end of the grub hoe blade, said first blade substantially sharp for cutting;
a second blade on a first side of the grub hoe blade, said second blade substantially sharp for cutting; and
a third blade on a second side of the grub hoe blade, said third blade substantially sharp for cutting; and
a means for attaching an end of the elongated handle to the grub hoe blade, the attaching means approximately perpendicular with the proximal end of the arcuate grub hoe blade and defining the longitudinal central axis of the grub hoe blade.

9. The garden tool of claim 8 wherein the first blade is substantially straight.

10. The garden tool of claim 8 wherein the first blade is a rounded tip.
